(19) United States
(12) Patent Application Publication
(10) Pub. No.: US 2025/0343426 A1
(43) Pub. Date: Nov. 6, 2025

(54) CHARGING BOX AND SHOOTING APPARATUS

(71) Applicant: ARASHI VISION INC., Shenzhen (CN)

(72) Inventors: Guoxing ZHANG, Shenzhen (CN); Fei GAO, Shenzhen (CN); Jun CHEN, Shenzhen (CN)

(73) Assignee: ARASHI VISION INC., Shenzhen (CN)

(21) Appl. No.: 19/273,033

(22) Filed: Jul. 17, 2025

Related U.S. Application Data
(63) Continuation of application No. PCT/CN2024/072589, filed on Jan. 16, 2024.

(30) Foreign Application Priority Data
Jan. 18, 2023 (CN) 202320223168.3

(51) Int. Cl. H02J 7/00; G03B 17/56; H04N 23/63

(52) U.S. Cl. CPC H02J 7/0045; G03B 17/56; H04N 23/63

(57) ABSTRACT

In some aspects, a charging box of a shooting device, including a box body and a display screen, is provided. The box body can be configured to detachably receive the shooting device and control the shooting device to capture images. The box body is signal-connected to the shooting device. The display screen can be electrically connected to the box body and configured to display the images captured by the shooting device. The display screen is arranged at one side of the box body.

### CROSS-REFERENCE TO RELATED APPLICATION

This application is a continuation of International Application No. PCT/CN2024/072589, filed on Jan. 16, 2024, which claims the benefit of priority to Chinese Patent Application No. 202320223168.3, filed on Jan. 18, 2023. The entire contents of these applications are hereby incorporated by reference in their entireties.

### BACKGROUND

The embodiments of the present disclosure relate to the field of shooting devices, and particularly relate to a charging box and shooting apparatus.

A charging box is a common electronic product accessory, which is usually used together with devices such as cameras, earphones, etc. The charging box mainly serves the functions of accommodating electronic products and charging electronic products.

In the field of shooting, the charging box usually only serves the function of charging the camera, and its function is relatively simple, resulting in a poor user experience.

### SUMMARY

The main technical problem solved by the embodiments of the present disclosure is to provide a charging box and shooting apparatus, aiming to solve the problem of the relatively simple function of the charging box in the related art.

To solve the above technical problem, one technical solution adopted by the embodiments of the present disclosure is: to provide a charging box, applicable to a shooting device, the charging box includes:
a box body, the shooting device can be detachably received in the box body, the box body is signal-connected to the shooting device, and the box body is used to control the shooting device to capture images; and
a display screen, arranged at one end of the box body, the display screen is electrically connected to the box body, and the display screen is used to display images captured by the shooting device.

In some embodiments, the box body is provided with an accommodating cavity. The box body includes a housing, a circuit board, and an electrical connector. The accommodating cavity is arranged in the housing. The housing is further provided with a mounting cavity on a side away from the accommodating cavity, and the circuit board is received in the mounting cavity. The electrical connector is electrically connected to the circuit board. The electrical connector is arranged in the mounting cavity and one end of the electrical connector is embedded in the housing, and when the shooting device is received in the accommodating cavity, the shooting device engages the electrical connector to establish an electrical connection.

In some embodiments, the box body further includes a battery. The battery is received in the housing. The battery is electrically connected to the circuit board, and the battery is used to provide power.

In some embodiments, the box body further includes a control button, the control button is arranged on the housing, the control button is electrically connected to the circuit board, and the control button is used to control the shooting device.

In some embodiments, the box body further includes a communication module. The communication module is arranged on the housing. The communication module is electrically connected to the circuit board, and the communication module is used to establish a signal connection with the shooting device.

In some embodiments, the display screen is rotatably connected to the box body to be fitted with the box body or connected to the box body at an angle. The display screen includes a display surface, and when the display screen is fitted with the box body, the display surface is disposed opposite to the accommodating cavity.

In some embodiments, the box body further includes a speaker. The speaker is received in the mounting cavity, and the speaker is electrically connected to the circuit board.

In some embodiments, the box body further includes a vibrating element. The vibrating element is arranged in the mounting cavity, and the vibrating element is electrically connected to the circuit board.

In some embodiments, one side of the housing is provided with a connecting portion. At least two connecting portions are arranged. The two connecting portions are arranged at intervals, and the connecting portion is used to provide a connection basis for an external releasable device, so that the releasable device is connected to the housing.

In some embodiments, the box body further includes a first magnet and a second magnet, the first magnet is embedded in the housing, and the first magnet is used to magnetically attract the releasable device; and
the second magnet is arranged in the mounting cavity and corresponds to the accommodating cavity, and the second magnet is used to magnetically attract the shooting device.

In some embodiments, the box body further includes a clamping member. The clamping member is arranged in the accommodating cavity and can be rotatably disposed relative to the housing. The clamping member is used to rotate to clamp the shooting device in the accommodating cavity, or to allow the shooting device to exit the accommodating cavity.

In some embodiments, the box body further includes a trigger and a switch. The trigger is received in the mounting cavity. One end of the trigger penetrates the cavity wall of the mounting cavity and extends into the accommodating cavity. The switch is arranged in the mounting cavity and disposed opposite to the trigger. The switch is electrically connected to the circuit board; when the shooting device is received in the accommodating cavity. The trigger moves toward the switch and causes the switch to generate an electrical signal indicating that the shooting device is received in the accommodating cavity.

In some embodiments, the housing includes an outer frame, an inner frame, and a middle frame. The outer frame is sleeved on the inner frame. The middle frame is arranged between the outer frame and the inner frame, and the material of the middle frame is metal.

The embodiments of the present disclosure further provide shooting apparatus, including:
a shooting device; and
the charging box as described in any of the above, where the shooting device can be detachably received in the charging box.

In some embodiments, when the shooting device is detached from or received in the charging box, the display screen can selectively display images/videos captured by the shooting device.

In some embodiments, the display screen is a touch display screen and can be used to control the shooting device.

In some embodiments, when the charging box establishes a communication connection or an electrical connection with the shooting device, the charging box generates a vibration to provide feedback to a user.

The beneficial effects of the embodiments of the present disclosure are as follows. Different from the situation in the related art, the embodiments of the present disclosure provide a charging box and shooting apparatus. The charging box is applicable to a shooting device. The charging box includes a box body and a display screen. The box body is provided with an accommodating cavity, and the shooting device can be detachably received in the accommodating cavity. The box body is electrically connected or signal-connected to the shooting device, and when the shooting device is received in the accommodating cavity, the box body is electrically connected to the shooting device to transmit electric power and electrical signals. When the shooting device is taken out from the accommodating cavity, the box body is signal-connected to the shooting device, and there is an electrical connection or signal connection between the box body and the shooting device. The housing controls the shooting device to capture images through electrical signals. When the shooting device is received in the accommodating cavity, the electrical connection between the box body and the shooting device can be configured to charge the shooting device, and the box body can be used to control the charging of the shooting device. The display screen is arranged at one end of the box body. The display screen is electrically connected to the box body, and the display screen is used to display images captured by the shooting device. When the shooting device is received in the accommodating cavity, the shooting device is electrically connected to the box body. The shooting device transmits the captured image information to the box body, and the box body then transmits the image information to the display screen, so that when the shooting device is received in the accommodating cavity, the display screen can display the images captured by the shooting device. When the shooting device is taken out from the accommodating cavity, the shooting device transmits the captured image information to the box body through a signal connection, and the box body then transmits the image information to the display screen, so that when the shooting device is separated from the box body, the display screen can still display the images captured by the shooting device. Compared with the charging box in the related art, the charging box proposed in the present disclosure has the function of displaying captured images, and regardless of whether the shooting device is received in the accommodating cavity of the box body, the display screen of the charging box can display the images captured by the shooting device to provide a shooting preview, which can help the user to capture higher quality videos or photos.

### BRIEF DESCRIPTION OF DRAWINGS

In order to more clearly illustrate the specific embodiments of the present disclosure or the technical solutions in the related art, the drawings required for the description of the specific embodiments or the related art will be briefly introduced below. In all the drawings, similar elements or parts are generally identified by similar reference numerals. In the drawings, the elements or parts are not necessarily drawn to actual scale.

FIG. 1 is a perspective view of a shooting apparatus, in which a shooting device is received in a charging box, according to some embodiments of the present disclosure.

FIG. 2 is another perspective view of the shooting apparatus having the shooting device and the charging box, according to some embodiments of the present disclosure.

FIG. 3 is a perspective view of the charging box, according to some embodiments of the present disclosure.

FIG. 4 is a top view of the charging box, according to some embodiments of the present disclosure.

FIG. 5 is a schematic diagram of a partial structure of the charging box, in which a cavity wall of an accommodating cavity is omitted, according to some embodiments of the present disclosure.

FIG. 6 is an exploded view of the charging box, according to some embodiments of the present disclosure.

FIG. 7 is a rear view of FIG. 6, according to some embodiments of the present disclosure.

FIG. 8 is a sectional view along A-A of FIG. 4, according to some embodiments of the present disclosure.

FIG. 9 is another schematic diagram of a partial structure of the charging box, according to some embodiments of the present disclosure.

FIG. 10 is a sectional view along B-B of FIG. 4, according to some embodiments of the present disclosure.

FIG. 11 is a schematic diagram of the usage state of the display screen of the charging box, according to some embodiments of the present disclosure.

The present disclosure will be described with reference to the accompanying drawings.

### DETAILED DESCRIPTION

In order to facilitate understanding of the embodiments of the present disclosure, the embodiments of the present disclosure will be described in more detail below in conjunction with the accompanying drawings and specific embodiments. It should be noted that when an element is described as being “fixed to” another element, it may be directly on the other element, or one or more intervening elements may be present therebetween. When an element is described as being “connected” to another element, it may be directly connected to the other element, or one or more intervening elements may be present therebetween. The terms “vertical,” “horizontal,” “left,” “right,” and similar expressions used in this specification are for illustrative purposes only, and they are given relative to a reference position.

Unless otherwise defined, all technical and scientific terms used in this specification have the same meaning as commonly understood by those skilled in the art to which the embodiments of the present disclosure belong. The terms used in the specification of the embodiments of the present disclosure are only for the purpose of describing specific embodiments and are not intended to limit the embodiments of the present disclosure. The term “and/or” as used in this specification includes any and all combinations of one or more of the associated listed items.

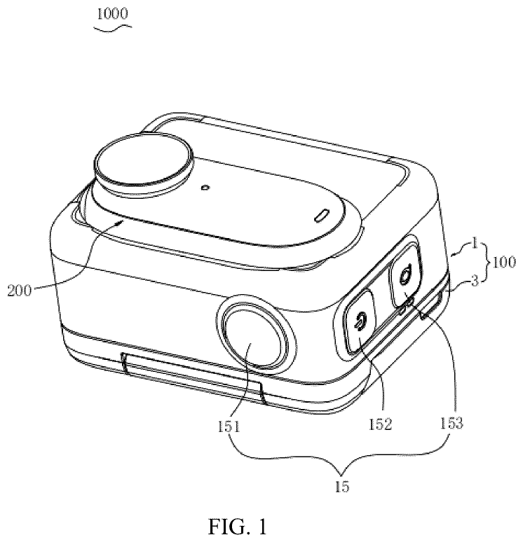

Please refer to FIG. 1 to FIG. 3. In some aspects, the present disclosure provides a charging box 100. The charging box 100 is applicable to a shooting device 200. In some examples, the charging box 100 and the shooting device 200 can be physically connected, e.g., being assembled together. As such, the charging box 100 can be electrically connected to and/or coupled to the shooting device 200. The shooting device 200 includes but is not limited to an action camera, a drone, a camera, and the like. The charging box 100 may include a box body 1 and a display screen 3. The box body 1 can be substantially rectangular, and the box body 1 can be provided with an accommodating cavity 114. The shooting device 200 can be detachably received in the accommodating cavity 114. The term “detachably” may refer to a state in which the shooting device 200 can be received in the accommodating cavity 114 and can also be taken out from the accommodating cavity 114.

The box body 1 is electrically connected or signal-connected (e.g., by wired or wireless coupling) to the shooting device 200. In some examples, when the shooting device 200 is received or placed in the accommodating cavity 114, and the box body 1 is electrically connected to the shooting device 200 to transmit electric power and electrical signals. As used herein, the terms “signal-connected” or “signal-connection” may refer to a state or configuration in which two components are connected in a manner that enables transmission of data or control signals between them. This connection may be established through either wired means (e.g., electrical conductors or connectors) or wireless means (e.g., Bluetooth, Wi-Fi, infrared, induction, or any other suitable electromagnetic communication technology), and is not limited to any particular communication protocol or physical interface.

When the shooting device 200 is taken out from the accommodating cavity 114, the box body 1 is signal-connected to the shooting device 200, and the signal connection can be established by using technologies, such as Bluetooth and WIFI. It can be understood that the specific signal connection method between the box body 1 and the shooting device 200 is not limited to Bluetooth and WIFI, which are only examples and should not be construed as limiting the embodiments of the present disclosure.

As there exists an electrical connection or signal connection between the box body 1 and the shooting device 200, the housing 11 can be configured to control the shooting device 200 to capture images through electrical signals. When the shooting device 200 is received or placed in the accommodating cavity 114, the electrical connection between the box body 1 and the shooting device 200 can be configured to charge the shooting device 200, and the box body 1 can be configured to control the charging of the shooting device 200.

Please refer to FIG. 1. In some embodiments, the display screen 3 can be arranged at one end (e.g., one side) of the box body 1. The display screen 3 is electrically connected to the box body 1, and the display screen 3 can be configured to display images captured by the shooting device 200. In some embodiments, when the shooting device 200 is received or placed in the accommodating cavity 114, the shooting device 200 can be electrically connected to the box body 1. Consequently, the shooting device 200 can transmit the captured image information to the box body 1, and the box body 1 can then transmit the image information to the display screen 3. Accordingly, when the shooting device 200 is received or placed in the accommodating cavity 114, the display screen 3 can display the images captured by the shooting device 200.

When the shooting device 200 is taken out from the accommodating cavity 114, the shooting device 200 can transmit the captured image information to the box body 1 through a signal connection, and the box body 1 can then transmit the image information to the display screen 3. Consequently, when the shooting device 200 is separated from the box body 1 (taken out from the accommodating cavity 114), the display screen 3 can still display the images captured by the shooting device 200.

Compared with the charging box 100 in the related art, the charging box 100 proposed in the present disclosure has the function of displaying captured images, and regardless of whether the shooting device 200 is received or placed in the accommodating cavity 114 of the box body 1, the display screen 3 of the charging box 100 can display the images captured by the shooting device 200 to provide a shooting preview, thus helping the user capture higher quality videos or photos.

For example, in outdoor sports scenarios, the shooting device 200 is usually separated from the charging box 100; thus, the shooting device 200 can obtain more different viewing angles. For example, the shooting device 200 can be lifted by a selfie stick or a drone and the like. As the shooting device 200 is separated from the charging box 100, at this time, the display screen 3 of the charging box 100 can be configured to view the images captured by the shooting device 200, facilitating timely adjustment of the shooting angle of the shooting device 200 to obtain high-quality photos or videos.

When shooting indoors or in a fixed position, when it is not necessary to frequently adjust the position of the shooting device 200, the shooting device 200 can be received in the accommodating cavity 114 of the charging box 100. The display screen 3 of the charging box 100 can be configured to view the images captured by the shooting device 200 to obtain a preview, therefore obtaining high-quality photos or videos. At the same time, the charging box 100 can also provide power for the shooting device 200, thereby increasing the usage time of the shooting device 200.

Regardless of whether the shooting device 200 is received in the box body 1, the display screen 3 can display the images captured by the shooting device 200. This is not limited to the case where the display screen 3 is always configured to display the images captured by the shooting device 200. It can be understood that the display screen 3 can selectively display the images captured by the shooting device 200. In one embodiment, the display screen 3 is a touch display screen, and the user can control the shooting device 200 by touching the display screen 3, for example, adjusting the shooting parameters of the shooting device 200, switching the shooting mode of the shooting device 200, and so on.

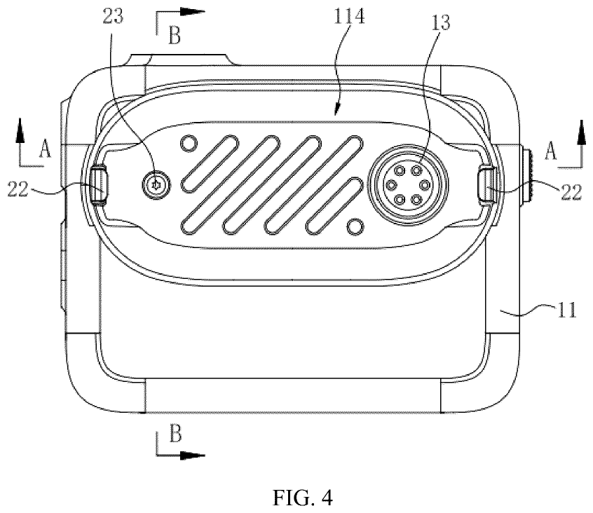

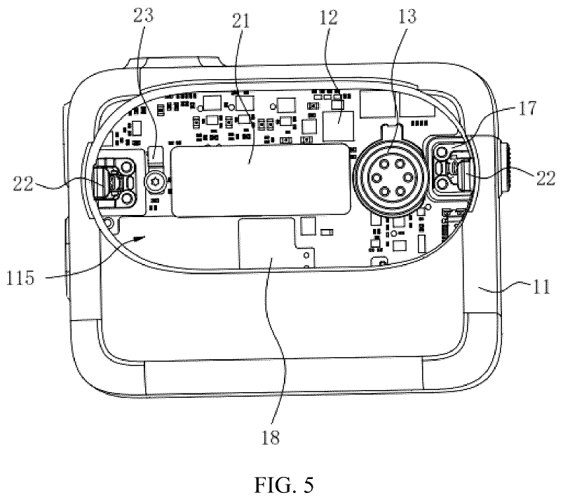

Please refer to FIG. 4 and FIG. 5. In some embodiments, the box body 1 can include a housing 11, a circuit board 12, and an electrical connector 13. The housing 11 is provided with an accommodating cavity 114, and the accommodating cavity 114 is provided with an opening to facilitate the placement and removal of the shooting device 200. In some examples, the housing 11 is further provided with a mounting cavity 115 on a side away from the accommodating cavity 114, and the mounting cavity 115 is configured to provide installation space for other components. The circuit board 12 is configured to provide an electrical connection basis, and in some examples, the circuit board 12 is received in the mounting cavity 115. The electrical connector 13 is configured to transmit, e.g., electric power and electrical signals. In some examples, the electrical connector 13 is arranged in the mounting cavity 115. In some examples, one end of the electrical connector 13 is embedded in the surface of the housing 11, and the other end of the electrical connector 13 is electrically connected to the circuit board 12. Therefore, when the shooting device 200 is received or placed in the accommodating cavity 114, the shooting device 200 engages the electrical connector 13 to establish an electrical connection.

Correspondingly, the shooting device 200 can be provided with an exposed electrode or plug at a position corresponding to the electrical connector 13. When the shooting device 200 is received or placed in the accommodating cavity 114, the exposed electrode or plug can be configured to contact the electrical connector 13.

In some embodiments, the electrical connector 13 is a pogo pin (spring pin), which is a precision connector used in electronic products such as mobile phones and is widely used in semiconductor devices for connection. The pogo pin has the advantages of corrosion resistance, stability, and durability. In other embodiments, the electrical connector 13 may also be an electrode made of a conductor. The present is not limited thereto.

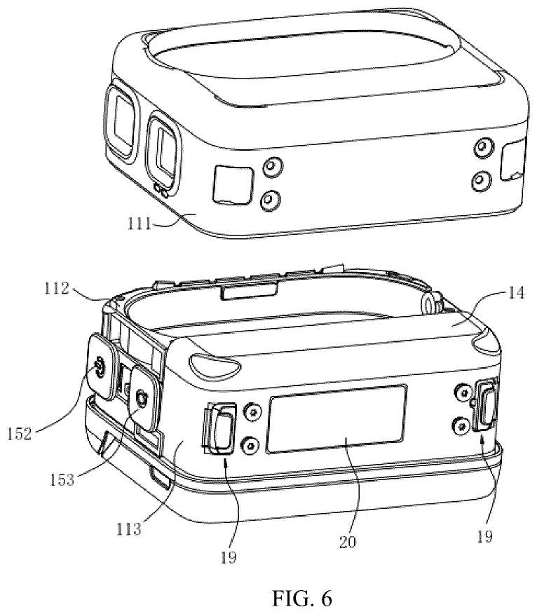

Please refer to FIG. 6. In some embodiments, the box body 1 may further include a battery 14. The battery 14 can be arranged in the housing 11. The battery 14 is electrically connected to the circuit board 12, and the battery 14 is configured to provide power. In some embodiments, the battery 14 is configured to provide power to the display screen 3 and the shooting device 200. When the shooting device 200 is received or placed in the accommodating cavity 114, the battery 14 can be configured to supply power to the shooting device 200 through the electrical connector 13. The battery 14 may be a built-in rechargeable battery 14 or a detachable battery 14. In some embodiments, the battery 14 can be received in the mounting cavity 115.

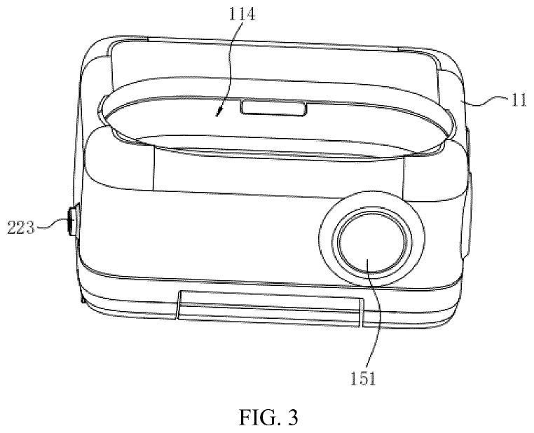

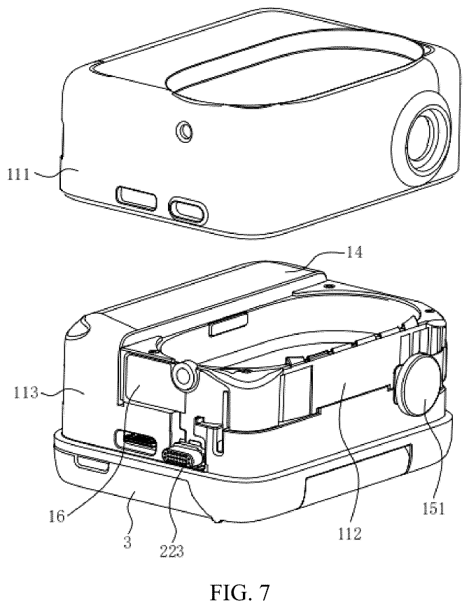

Please refer to FIG. 1, FIG. 3, and FIG. 7. In some embodiments, the box body 1 can further include a control button 15. The control button 15 is arranged on the housing 11, and in some examples, the control button is arranged on the outer surface of the housing 11 to facilitate the user's operation of the control button 15. The control button 15 is electrically connected to the circuit board 12, and the control button 15 is configured to control the shooting device 200.

In some embodiments, when the shooting device 200 is received or placed in the accommodating cavity 114, an electrical connection is established between the shooting device 200 and the charging box 100. Accordingly, pressing the control button 15 can control the shooting device 200. When the shooting device 200 is separated from the box body 1 (taken out from the accommodating cavity 114), as the shooting device 200 and the box body 1 are wirelessly connected, the information of pressing the control button 15 can be transmitted to the shooting device 200 wirelessly, thereby realizing the control of the shooting device 200 to capture images.

In some embodiments, please refer to FIG. 1, the control button 15 may include a shutter button 151, a power button 152, and a switching button 153. In some examples, the shutter button 151 is configured to control the shooting device 200 to take photos or record videos. The power button 152 is configured to control the power on/off of the charging box 100. The switching button 153 is configured to control the switching of the shooting device 200 between various modes and the selection among various parameters.

Please refer to FIG. 7. In some embodiments, the box body 1 further includes a communication module 16. In some examples, the communication module 16 is arranged on the housing 11. The communication module 16 can be electrically connected to the circuit board 12. The communication module 16 may include an antenna. The communication module 16 can transmit and receive electromagnetic waves, and the communication module 16 is configured to establish a signal connection with the shooting device 200, thereby establishing a signal connection between the shooting device 200 and the box body 1.

The working principle of the communication module 16 can refer to related technology. The present disclosure is not limited thereto. In some examples, the communication module 16 can be embedded inside the housing 11 or attached to the surface of the housing 11. In some embodiments, the communication module 16 is an antenna, and the shooting device 200 and the box body 1 are signal-connected through, e.g., Bluetooth, and the antenna is embedded inside the housing 11. It should be understood that the signal connection method between the shooting device 200 and the box body 1 is not limited to Bluetooth connection, and may also be other connection methods such as wireless local area network.

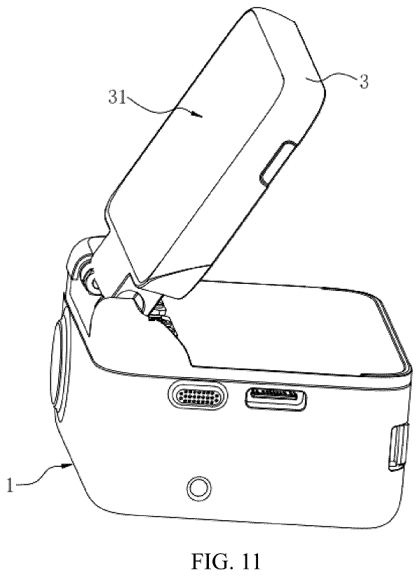

Please refer to FIG. 1 and FIG. 11. In some embodiments, the display screen 3 is rotatably connected to the box body 1 to be fitted with the box body 1 or connected to the box body 1 at an angle. The display screen 3 can include a display surface 31, and when the display screen 3 is flush-fitted with the box body 1 (for instance, stowed against the box body 1), the display surface 31 is disposed opposite to the accommodating cavity 114.

During use, the display screen 3 is rotated so that there is an angle between the display surface 31 of the display screen 3 and the box body 1, thereby facilitating the user to view the display surface 31. After use, the display screen 3 is rotated to fit flush with the box body 1 (e.g., received in or aligned with the box body 1, or stowed against the box body 1), so as to store the display screen 3 and make the display screen 3 and the box body 1 integrally arranged.

In some embodiments, the display surface 31 of the display screen 3 may also be arranged on the side of the display screen 3 facing the box body 1. The display screen 3 can be rotated relative to the box body 1 so that the display surface 31 fits with the box body 1 or is connected to the box body 1 at an angle. When the display screen 3 is opened, it is convenient for the user to observe. When the display screen 3 is closed, it can protect the display surface 31 and reduce the probability of damage due to impact.

Please refer to FIG. 5. In some embodiments, the box body 1 may further include a speaker 17. In some examples, the speaker 17 is received in the mounting cavity 115, and the speaker 17 is electrically connected to the circuit board 12. When the shooting device 200 is shooting a video, the sound in the video is played through the speaker 17 to provide a better experience for the user. In some examples, the housing 11 can be provided with a sound hole corresponding to the speaker 17 (not shown in the figure) to facilitate the transmission of the sound emitted by the speaker 17 to the outside of the box body 1.

Please refer to FIG. 5. In some embodiments, the box body 1 may further include a vibrating element 18. In some examples, the vibrating element 18 is arranged in the mounting cavity 115. The vibrating element 18 is electrically connected to the circuit board 12, and the vibrating element 18 is configured to provide vibration. For example, when the shooting device 200 and the box body 1 have started to establish or just established a communication connection or an electrical connection, the vibrating element 18 vibrates to provide feedback to the user. It can be understood that the application scenarios of the vibrating element 18 are not limited to this. The present disclosure only provides an example, and this example should not be construed as limiting the embodiments of the present disclosure. In some examples, the vibrating element 18 may include but is not limited to a vibration motor, a linear motor, and the like.

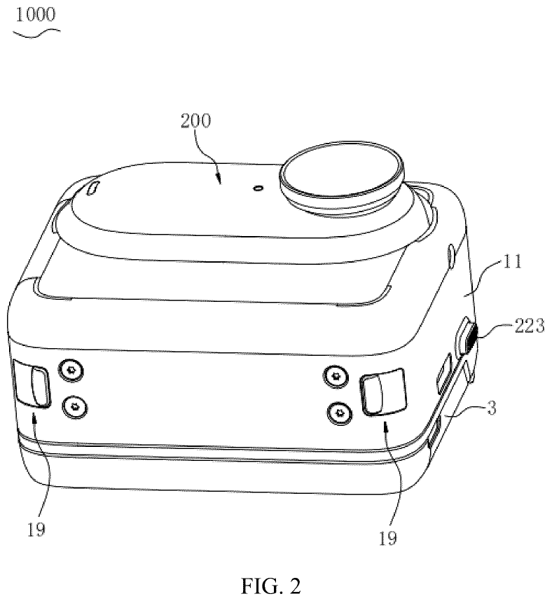

Please refer to FIG. 2 and FIG. 6. In some embodiments, at least one side of the housing 11 is provided with a connecting portion 19. In some examples, at least two connecting portions 19 can be arranged, and the two connecting portions 19 can be arranged at intervals. The connecting portion 19 is configured to provide a connection basis for an external releasable device (not shown in the figure). Accordingly, the releasable device is connected to the housing 11. The releasable device is usually an external functional module, which is configured to connect with a selfie stick or a tripod and the like. As such, when the box body 1 is connected with the releasable device, it can be mounted on the selfie stick or the tripod through the releasable device.

In some embodiments, the connecting portion 19 can be a groove. Correspondingly, the releasable device is provided with a movable hook, the opening angle of the hook of the releasable device is adjusted, and then the hook is inserted into the slot, so that the releasable device can be attached to the housing 11.

In some embodiments, the connecting portion 19 may also be a clamping protrusion (not shown in the figure). Correspondingly, the releasable device is provided with a slot (not shown in the figure), and the releasable device is mounted on the housing 11 through the cooperation of the clamping protrusion and the slot.

Please refer to FIG. 5 and FIG. 6. In some embodiments, the box body 1 may further include a first magnet 20 and a second magnet 21. The first magnet 20 is embedded in the housing 11. In some embodiments, the first magnet 20 can be embedded in the surface of the housing 11 or embedded in the interior of the housing 11. The first magnet 20 is configured to magnetically attract the releasable device. Correspondingly, the releasable device is provided with a part made of a ferromagnetic material corresponding to the first magnet 20, such as an iron block, a nickel block, and the like, which is configured be mutually attracted with the first magnet 20, thereby improving the connection strength between the releasable device and the housing 11.

In some examples, the first magnet 20 is arranged between the two connecting portions 19. When installing the releasable device, two ends of the releasable device are fixed by the connecting portions 19, and the middle part of the releasable device close to the box body 1 is attached to the surface of the box body 1 under the attraction of the first magnet 20, which can increase the connection stability of the releasable device.

In some embodiments, the releasable device is provided with a magnet that is mutually attracted to the first magnet 20, and the magnetic pole of the magnet is opposite to the magnetic pole of the first magnet 20, so that a magnetic attraction force can be generated between the first magnet 20 and the magnet.

Please refer to FIG. 5. The second magnet 21 is arranged in the mounting cavity 115 and corresponds to the accommodating cavity 114, and the second magnet 21 is configured to magnetically attract the shooting device 200. Correspondingly, the releasable device is provided with a part made of a ferromagnetic material corresponding to the first magnet 20, such as an iron block, a nickel block, and the like, which is configured to be mutually attracted with the first magnet 20, thereby reducing the probability of the shooting device 200 being separated from the accommodating cavity 114.

In some embodiments, the shooting device 200 is provided with a magnet that is mutually attracted to the first magnet 20, and the magnetic pole of the magnet is opposite to the magnetic pole of the first magnet 20, so that a magnetic attraction force can be generated between the first magnet 20 and the magnet.

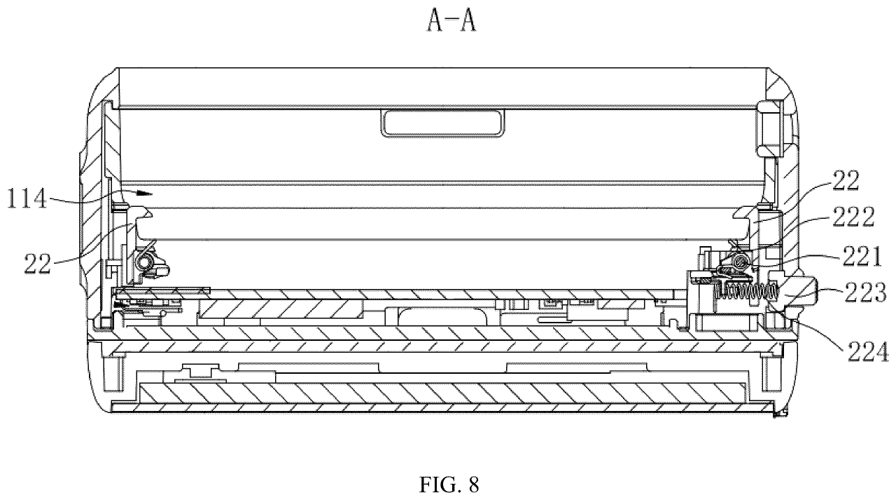

Please refer to FIG. 4, FIG. 5, and FIG. 8. In some embodiments, the box body 1 may further include a clamping member 22. In some examples, the clamping member 22 can be arranged in the accommodating cavity 114, and the clamping member 22 can be rotatably disposed relative to the housing 11. In some embodiments, one end of the clamping member 22 penetrates the cavity wall of the accommodating cavity 114 and enters the mounting cavity 115. When the shooting device 200 is received or placed in the accommodating cavity 114, the clamping member 22 rotates and clamps the shooting device 200 to reduce the probability of the shooting device 200 being separated from the accommodating cavity 114. When it is necessary to take out the shooting device 200 from the accommodating cavity 114, the clamping member 22 rotates and separates from the shooting device 200, so that the shooting device 200 can be taken out from the accommodating cavity 114.

In some embodiments, two clamping members 22 are provided, and the two clamping members 22 are respectively arranged on two opposite cavity walls of the accommodating cavity 114. When the shooting device 200 is received or placed in the accommodating cavity 114, the two clamping members 22 rotate and move toward each other to clamp the shooting device 200.

The clamping member 22 may be hook-shaped, sheet-shaped, block-shaped, or other irregular shapes. The present disclosure is not limited thereto. In some embodiments, the clamping member 22 is a hook, the end of the hook close to the opening of the accommodating cavity 114 is the top end, the top end of the hook is generally “L”-shaped, and the top end of the hook is arranged toward the center of the accommodating cavity 114 to clamp the shooting device 200.

Please refer to FIG. 8 and FIG. 9. The box body 1 may further include a rotating shaft 221 and a reset torsion spring 222. In some examples, the rotating shaft 221 is generally cylindrical and is arranged in the accommodating cavity 114. For convenience of description, the end of the clamping member 22 far from the opening of the accommodating cavity 114 is referred to as the bottom end, and the end of the clamping member 22 close to the opening of the accommodating cavity 114 is referred to as the top end. The rotating shaft 221 passes through the part between the top end and the bottom end of the clamping member 22, so that the clamping member 22 can rotate relative to the housing 11.

Please refer to FIG. 9. The reset torsion spring 222 is sleeved on the rotating shaft 221 and is arranged corresponding to the clamping member 22. When the top end of the clamping member 22 rotates toward the side close to the corresponding cavity wall, the reset torsion spring 222 generates a torque to restore the clamping member 22 to the initial position. During the process of placing the shooting device 200 into the accommodating cavity 114, the top end of the clamping member 22 first rotates toward the side close to the corresponding cavity wall, and at this time, the torque generated by the reset torsion spring 222 causes the top end of the clamping member 22 to abut against the shooting device 200. The two opposite clamping members 22 clamp the shooting device 200, which can reduce the probability of the shooting device 200 being separated from the accommodating cavity 114.

Please refer to FIG. 9. The box body 1 may further include an unlocking button 223, the unlocking button 223 penetrates the housing 11, and one end is located in the mounting cavity 115. For convenience of description, the end of the unlocking button 223 located in the mounting cavity 115 is referred to as the inner end, and the end of the unlocking button 223 located outside the housing 11 is referred to as the outer end. The inner end of the unlocking button 223 is arranged corresponding to the bottom end of the clamping member 22. When the outer end of the unlocking button 223 is pressed, the unlocking button 223 moves toward the inside of the mounting cavity 115 and pushes the bottom end of the clamping member 22. The bottom end of the clamping member 22 receives a pushing force, and the top end of the clamping member 22 rotates toward the side close to the cavity wall of the accommodating cavity 114. At this time, the clamping member 22 separates from the shooting device 200, thereby facilitating the user to take out the shooting device 200 from the accommodating cavity 114.

Please refer to FIG. 9. The box body 1 may further include a reset spring 224. In some examples, one end of the reset spring 224 is fixed, and the other end of the reset spring 224 abuts against the unlocking button 223. When the unlocking button 223 is not pressed, the reset spring 224 is in its original length state, so that the outer end of the unlocking button 223 protrudes from the housing 11. When the unlocking button 223 is pressed, the reset spring 224 is in a compressed state. When the external force pressing the reset spring 224 disappears, the spring returns to its original length to provide an elastic force, so that the unlocking button 223 returns to the initial position.

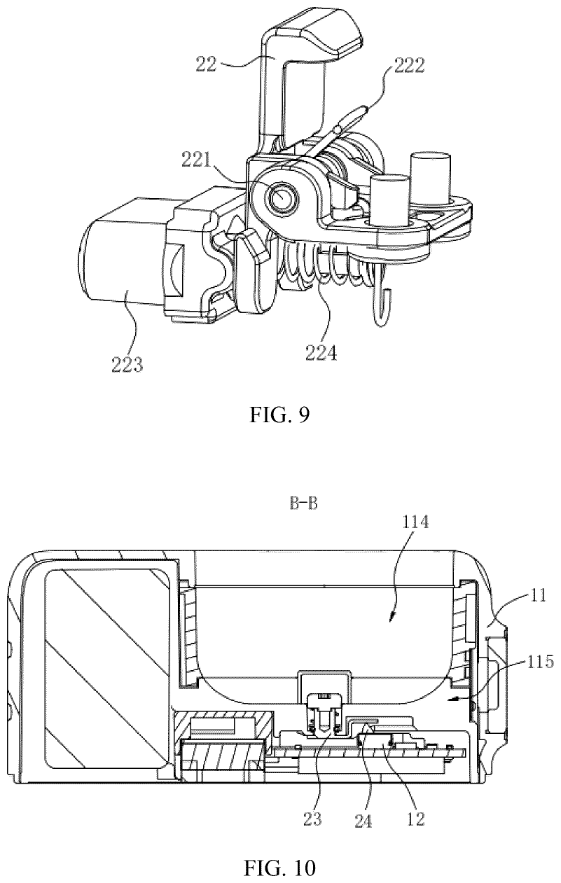

Please refer to FIG. 4 and FIG. 10. In some embodiments, the box body 1 may further include a trigger 23 and a switch 24. In some examples, the trigger 23 is received in the mounting cavity 115, and one end of the trigger 23 penetrates the cavity wall of the mounting cavity 115 and extends into the accommodating cavity 114. In some examples, the switch 24 is arranged in the mounting cavity 115 and is disposed opposite to the trigger 23, and the switch 24 is electrically connected to the circuit board 12. When the shooting device 200 is received or placed in the accommodating cavity 114, under the action of gravity of the shooting device 200, a force is applied to the trigger 23, and the trigger 23 moves toward the switch 24, causing the switch 24 to generate an electrical signal indicating that the shooting device 200 is received in the accommodating cavity, so that an electrical connection is established between the box body 1 and the shooting device 200.

The switch 24 is a normally closed switch. Therefore, when the shooting device 200 is separated from the accommodating cavity 114, the switch 24 is not energized, which can avoid electrical corrosion caused by the switch 24 being energized for a long time.

Please refer to FIG. 6 and FIG. 7. In some embodiments, the housing 11 may include an outer frame 111, an inner frame 112, and a middle frame 113. The outer frame 111 is the outer edge of the housing 11, and the inner frame 112 is the inner edge of the housing 11. The outer frame 111 is sleeved on the inner frame 112. The middle frame 113 is arranged between the outer frame 111 and the inner frame 112, and the material of the inner frame 112 is metal. Therefore, the middle frame 113 can absorb the heat emitted by the conductive components in the mounting cavity 115 and radiate the heat outward through the middle frame 113 to increase the heat dissipation effect of the box body 1. The middle frame 113 has a large surface area to increase the heat dissipation effect.

Correspondingly, the communication module 16 is arranged on the surface of the inner frame 112, and the communication module 16 may have a certain surface area to increase the ability of the communication module 16 to receive and transmit signals.

Correspondingly, the battery 14 is received in the middle frame 113 to fix the battery 14.

In some aspects, the present disclosure provides a charging box 10. The charging box 100 is applicable to a shooting device 200, and the charging box 100 includes a box body 1 and a display screen 3. The box body 1 is provided with an accommodating cavity, and the shooting device 200 can be detachably received in the accommodating cavity 114. The box body 1 is electrically connected or signal-connected to the shooting device 200. When the shooting device 200 is received or placed in the accommodating cavity 114, the box body 1 is electrically connected to the shooting device 200 to transmit electric power and electrical signals.

When the shooting device 200 is taken out from the accommodating cavity 114, the box body 1 is signal-connected to the shooting device 200. As there is always an electrical connection or signal connection between the box body 1 and the shooting device 200, the shooting device 200 can be controlled to capture images through electrical signals between the housing 11 and the shooting device 200. When the shooting device 200 is received or placed in the accommodating cavity 114, the electrical connection between the box body 1 and the shooting device 200 can be configured to charge the shooting device 200. Therefore, the box body 1 can be configured to control the charging of the shooting device 200.

In some examples, the display screen 3 is arranged at one end of the box body 1, the display screen 3 is electrically connected to the box body 1, and the display screen 3 is configured to display images captured by the shooting device 200. When the shooting device 200 is received or placed in the accommodating cavity 114, the shooting device 200 is electrically connected to the box body 1, and the shooting device 200 transmits the captured image information to the box body 1, and the box body 1 then transmits the image information to the display screen 3, so that when the shooting device 200 is received or placed in the accommodating cavity 114, the display screen 3 can display the images captured by the shooting device 200. When the shooting device 200 is taken out from the accommodating cavity 114, the shooting device 200 transmits the captured image information to the box body 1 through a signal connection, and the box body 1 then transmits the image information to the display screen 3, so that when the shooting device 200 is separated from the box body 1, the display screen 3 can still display the images captured by the shooting device 200.

Compared with the related art, the charging box 100 proposed in the present disclosure has the function of displaying captured images, and regardless of whether the shooting device 200 is received or placed in the accommodating cavity 114 of the box body 1, the display screen 3 of the charging box 100 can display the images captured by the shooting device 200 to provide a shooting preview, which can help the user to capture higher quality videos or photos.

Please refer to FIG. 1, FIG. 2, and FIG. 3. In some embodiments, the present disclosure further provides a shooting apparatus 1000. In some examples, the shooting apparatus 1000 includes a shooting device 200 and the above charging box 100. The structure of the charging box 100 is described above, and the specific structure will not be described in detail herein.

The shooting device 200 has a shooting function and a wireless communication function. When the shooting device 200 is received in the charging box 100, the shooting device 200 and the charging box 100 are electrically connected to transmit electric power and electrical signals, so that the charging box 100 can charge the shooting device 200 and can control the shooting device 200 to capture images. The shooting device 200 transmits the captured images to the display screen 3 of the charging box 100 to facilitate shooting preview. When the shooting device 200 is separated from the charging box 100, the shooting device 200 is signal-connected to the charging box 100, the shooting device 200 transmits the captured images to the box body 1 of the charging box 100, and the box body 1 then transmits the electrical signals to the display screen 3 to facilitate shooting preview, which can help the user to capture higher quality videos or photos.

It should be noted that the specification and drawings of the embodiments of the present disclosure provide preferred embodiments of the present disclosure, but the embodiments of the present disclosure can be implemented in many different forms and are not limited to the embodiments described in this specification. These embodiments are not intended to be additional limitations on the content of the embodiments of the present disclosure. The purpose of providing these embodiments is to make the disclosure of the embodiments of the present disclosure more thorough and comprehensive. Furthermore, the above technical features continue to be combined with each other to form various embodiments not listed above, all of which are regarded as within the scope described in the specification of the embodiments of the present disclosure. Furthermore, those skilled in the art can make improvements or changes based on the above description, and all such improvements and changes should fall within the scope of protection of the claims of the embodiments of the present disclosure.

What is claimed is:

1. A charging box of a shooting device, comprising:
a box body configured to detachably receive the shooting device and control the shooting device to capture images, wherein the box body is signal-connected to the shooting device; and
a display screen electrically connected to the box body and configured to display the images captured by the shooting device, wherein the display screen is arranged at one side of the box body.

2. The charging box according to claim 1, wherein:
the box body is provided with an accommodating cavity;
the display screen is rotatably connected to the box body and configured to fit flush with the box body or be positioned at an angle relative to the box body; and
the display screen comprises a display surface, wherein when the display screen is flush-fitted with the box body, the display surface is disposed at a side of the box body facing away from the accommodating cavity.

3. The charging box according to claim 1, wherein:
the box body comprises a housing and a circuit board, and is provided with an accommodating cavity that is arranged in the housing;
the housing is further provided with a mounting cavity on a side away from the accommodating cavity; and
the circuit board is placed in the mounting cavity.

4. The charging box according to claim 3, wherein:
the box body further comprises an electrical connector electrically connected to the circuit board, the electrical connector being arranged in the mounting cavity, and one end of the electrical connector being embedded in the housing; and
when the shooting device is placed in the accommodating cavity, the shooting device engages the electrical connector to establish an electrical connection.

5. The charging box according to claim 4, wherein the box body further comprises a battery configured to provide power, the battery is placed in the housing and electrically connected to the circuit board.

6. The charging box according to claim 4, wherein the box body further comprises a control button arranged on the housing, the control button being electrically connected to the circuit board and configured to control the shooting device.

7. The charging box according to claim 4, wherein the box body further comprises a communication module configured to establish a signal connection with the shooting device, the communication module being arranged on the housing and electrically connected to the circuit board.

8. The charging box according to claim 3, wherein the box body further comprises a speaker placed in the mounting cavity and electrically connected to the circuit board.

9. The charging box according to claim 3, wherein the box body further comprises a vibrating element arranged in the mounting cavity and electrically connected to the circuit board.

10. The charging box according to claim 3, wherein:
the housing comprises at least two connecting portions arranged at intervals, each of the at least two connecting portions being configured to provide a connection basis for an external releasable device to enable the external releasable device to be connected to the housing.

11. The charging box according to claim 10, wherein:
the box body further comprises a first magnet and a second magnet;
the first magnet is embedded in the housing and configured to magnetically attract the external releasable device; and
the second magnet is arranged in the mounting cavity and corresponds to the accommodating cavity, the second magnet being configured to magnetically attract the shooting device.

12. The charging box according to claim 3, wherein:
the box body further comprises a clamping member, the clamping member being arranged in the accommodating cavity and rotatably arranged relative to the housing; and
the clamping member is configured to rotate to clamp the shooting device in the accommodating cavity or to allow the shooting device to exit the accommodating cavity.

13. The charging box according to claim 3, wherein:
the box body further comprises a trigger and a switch;
the trigger is placed in the mounting cavity, one end of the trigger penetrating a cavity wall of the mounting cavity and extending into the accommodating cavity;
the switch is arranged in the mounting cavity and disposed opposite to the trigger, the switch being electrically connected to the circuit board; and
when the shooting device is placed in the accommodating cavity, the trigger moves towards the switch to cause the switch to generate an electrical signal, the electrical signal being configured to indicate that the shooting device is placed in the accommodating cavity.

14. The charging box according to claim 1, wherein:
the box body comprises a housing;
the housing comprises an outer frame, an inner frame, and a middle frame that is made of a material containing metal; and
the outer frame is sleeved on the inner frame, and the middle frame is arranged between the outer frame and the inner frame.

15. A charging box of a shooting device, comprising:
a box body provided with a receiving space for detachably accommodating the shooting device, wherein the box body is configured to establish a signal-connection with the shooting device in a first state assembled with the shooting device and a second state detached from the shooting device to control the shooting device to capture images, and the box body is further configured to supply power to the shooting device; and
a display screen connected to the box body and configured to display the images captured by the shooting device, wherein the display screen faces away from a side of the box body for receiving the shooting device.

16. The charging box according to claim 15, wherein the display screen is configured to display the images captured by the shooting device when the shooting device is detached from the box body.

17. A shooting apparatus, comprising:
a shooting device; and
a charging box comprising:
a box body configured to detachably receive the shooting device and control the shooting device to capture images, wherein the box body is signal-connected to the shooting device; and
a display screen electrically connected to the box body and configured to display the images captured by the shooting device, wherein the display screen is arranged at one side of the box body.

18. The shooting apparatus according to claim 17, wherein when the shooting device is detached from the charging box, the display screen is configured to display the images captured by the shooting device.

19. The shooting apparatus according to claim 17, wherein the display screen is a touch display screen configured to control the shooting device.

20. The shooting apparatus according to claim 17, wherein when the charging box establishes at least one of a communication connection or an electrical connection with the shooting device, the charging box generates a vibration.
